(19) United States
(12) Patent Application Publication
(10) Pub. No.: US 2024/0260072 A1
(43) Pub. Date: Aug. 1, 2024

(54) RF CODE-DOMAIN SPREAD SPECTRUM CORRELATION FOR INTERFERENCE-TOLERATED COMMUNICATION AND RADAR TRANSCEIVERS

(71) Applicant: Digital Analog Integration, Inc., Auburn, AL (US)

(72) Inventors: Fa Dai, Auburn, AL (US); John David Irwin, Auburn, AL (US)

(21) Appl. No.: 18/160,053

(22) Filed: Jan. 26, 2023

(51) Int. Cl. H04W 72/541; H04K 3/00

(52) U.S. Cl. CPC H04W 72/541; H04K 3/20

(57) ABSTRACT

Code-domain spread spectrum (CDSS) correlation embodiments for wireless and radar transceivers with the dual purposes of in-band jammer rejection and transmitter-to-receiver self-interference suppression. The encode/decode schemes may be employed at different locations on the TRx paths such as TRx front-end and/or in the baseband, for different TR transceiver architectures such as I/Q TRx, MIMO/phase array TRx and polar TRx. The encoder may be placed in the baseband digital unit and the decoder may be placed in front-of-the LNA in the RF domain for easy encoder implementation in the digital domain while protecting the receiver path from interferences. Group delay filters and/or tunable time delays can be employed to compensate for a signal path delay in a radar TRx. Signals coded with a correlated code sequence and synchronized with the encoder in the transmitter may be decoded and restored at the receiver while the in-band jammers and self-interference can be suppressed.

### FIELD OF THE DISCLOSURE

The various embodiments of the disclosed technology relate generally to radio or radar transceiver architecture and building blocks, and in particular, to approaches for interference mitigations.

### BACKGROUND

Autonomous vehicles (AVs) rely on a set of radar sensors that operate on frequency-modulated waveforms that can occupy large bandwidth. As the AV market continues to grow, the available radio frequency (RF) spectrum for radar and/or other communications among vehicles will soon reach capacity.

FIG. 1 depicts an example scenario 100 in which RF interference can occur between a first vehicle 102 and a second vehicle 104 during communications among the associated transceivers and/or during radar sensing. The coexistence of multiple AVs working in the same spectrum presents challenges for so-called Radar-to-Radar (R2R) interference, also known as radar blindness. In a radar congestion scenario, co-existing radar signals, such as those transmitted from additional sources 106 (such as another AV or a jammer for example) can degrade driver-assistance system (ADAS) sensor performance, causing accidents and fatalities due to R2R interferences.

Code Domain Spread Spectrum (CDSS) techniques have been widely applied at baseband in applications such as Code Division Multiple Access (CDMA) communications. CDSS typically spreads a narrow band signal (such as interferers) into a wide band signal. Signals coded with the same correlated random sequence as the code used in the decoder can be recovered while other interferers are spread into the Nyquist band of the code modulation as noise.

Coding radar waveforms in the baseband has been explored to minimize the R2R interference among the vehicles in proximity and operating in the same frequency band. Specifically, the spread spectrum codes have been used as another degree of freedom along with time-frequency divisions to spread the inter-vehicular radar interference over the wider spectrum, which can orthogonalize a larger number of AVs over the available spectrum.

However, the conventional baseband coding scheme will not protect the receiver from being saturated or blocked since the decoder is placed in the baseband and the interferer can still penetrate the receiver path and desensitize its building blocks.

One of the RF CDSS correlation schemes was explored in Z. Chen, D. Liao, and F. Dai, “A Full-Duplex Transceiver Front-End RFIC with Code-Domain Spread Spectrum Modulation for Tx Self-Interference Cancellation and In-Band Jammer Rejection,” IEEE Custom Integrated Circuits Conference (CICC), April 2018, in which the encoder was placed before the power amplifier (PA) in the RF domain. This approach implements the encoder in RF frequency, which limits the choice of waveform coding to simple modulations such as on-off key or BPSK. Such simple modulation schemes often end up with poor bandwidth efficiency. In such schemes, the associated power amplifier needs to have high linearity and wide bandwidth, presenting challenges for encoder implementation at an mm-wave frequency such as 77 GHz used by ADAS radars. Furthermore, for proper decoding, the decoder in the receiver needs to be synchronized with the encoder to compensate for path delay.

There is a need for a CDSS encoder scheme that can be adopted with proper filtering and synchronized decoding including compensation for path delay in the transmitter and/or receiver, leading to more efficient bandwidth utilization for the transmitted spread signal.

### BRIEF SUMMARY

The disclosed technology includes transceiver systems and methods that may be utilized to reduce interference in communication and/or radar applications.

According to an exemplary implementation of the disclosed technology, a transceiver is disclosed that includes a duplexer in communication with an antenna, where the antenna is configured to transmit a radio frequency (RF) transmit signal and receive an RF receive signal. The transceiver includes a transmitter in communication with the duplexer. The transmitter includes a baseband code-domain spread spectrum (CDSS) encoder configured to encode a baseband transmit signal with a first orthogonal CDSS code. The transceiver includes a receiver in communication with the duplexer. The receiver includes an RF CDSS decoder configured to decode the RF receive signal using a second orthogonal CDSS code.

In accordance with another exemplary implementation of the disclosed technology, a method is provided for encoding a transmit signal in a baseband and receiving and filtering an RF signal in the RF domain. The method includes encoding a baseband transmit signal with a baseband CDSS encoder using a first orthogonal CDSS code, converting the encoded baseband transmit signal to an RF transmit signal, transmitting, with an antenna, the RF transmit signal, receiving, with the antenna, an RF receive signal, and decoding the RF receive signal with an RF CDSS decoder using a second orthogonal CDSS code to substantially pass portions of the RF receive signal that is encoded with the second orthogonal CDSS code.

In accordance with an exemplary implementation of the disclosed technology for a communication transceiver, the first and second orthogonal CDSS codes used in its transmitter and receiver may be different in order to avoid self-interferences. In this case, the receiver's CDSS code may be properly aligned in time by calibration with the code used by the partner's transmitter in order to compensate for the path delay of the signal. In an exemplary implementation of the disclosed technology for a radar transceiver, the first and second orthogonal CDSS codes used in the transmitter and receiver may be identical, but properly delayed in time with respect to one another in order to compensate for the path delay of the signal.

These and other aspects of the disclosed technology are described in the detailed description below. Certain aspects, features, and benefits of embodiments of the disclosed technology will become apparent to those of ordinary skill in the art upon reviewing the detailed description in conjunction with the associated figures. While certain features may be discussed with respect to certain embodiments and certain figures, all embodiments of the disclosed technology can include one or more of the features discussed herein. Further, while one or more embodiments may be discussed as having certain advantageous features, one or more of such features may also be used with the various embodiments discussed herein. In a similar fashion, while exemplary implementations may be discussed below as device, system, or method embodiments, it is to be understood that such embodiments can be implemented in various devices, systems, and methods of the disclosed technology.

### BRIEF DESCRIPTION OF THE DRAWINGS

The following detailed description of specific embodiments of the disclosure will be better understood when read in conjunction with the appended drawings. It should be understood, however, that the disclosure is not limited to the precise arrangements and instrumentalities of the embodiments shown in the drawings.

FIG. 1 is an example illustration of radio frequency (RF) interference that can occur during communications among transceivers and/or during radar sensing.

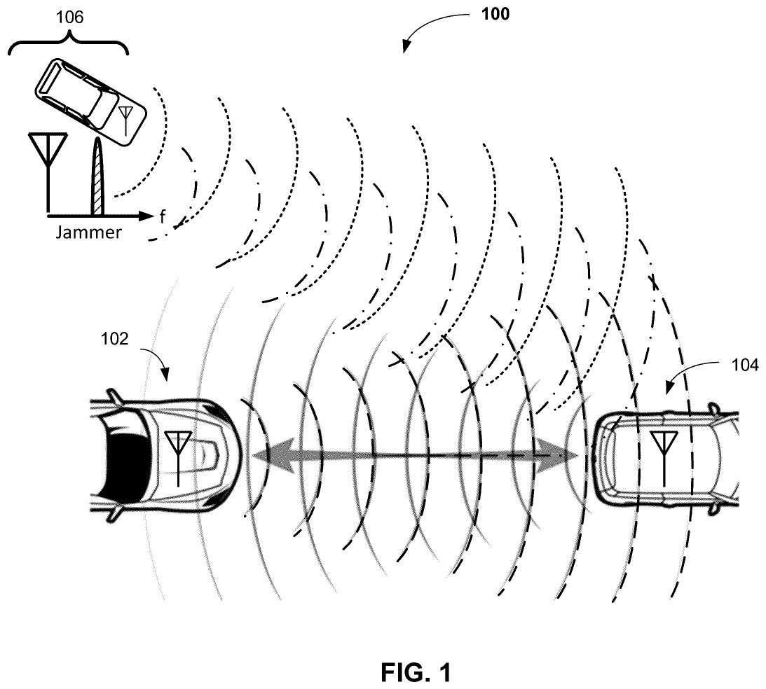

FIG. 2 is a conceptual block diagram system employing communication transceivers with RF domain CDSS correlators for interference mitigations, in accordance with an exemplary embodiment of the disclosed technology.

FIG. 3 illustrates a first exemplary embodiment of a transceiver architecture with RF domain CDSS correlators for inter- and inner-radio interference mitigations in accordance with an exemplary embodiment of the disclosed technology.

FIG. 4 illustrates a second exemplary embodiment of a transceiver architecture with an RF domain CDSS decoder and a baseband CDSS encoder for inter- and inner-radio interference mitigations in accordance with an exemplary embodiment of the disclosed technology.

FIG. 5 illustrates a third example embodiment of a transceiver architecture with RF domain CDSS correlators for inter- and inner-radio interference mitigations, in accordance with an exemplary embodiment of the disclosed technology.

FIG. 6 illustrates a fourth example embodiment of a MIMO or phased array transceiver architecture with RF domain CDSS correlators for inter- and inner-radio interference mitigations, in accordance with an exemplary embodiment of the disclosed technology.

FIG. 7 illustrates a fifth example embodiment of a polar transceiver architecture with RF domain CDSS correlators for inter- and inner-radio interference mitigations in accordance with an exemplary embodiment of the disclosed technology.

FIG. 8 illustrates a sixth example embodiment of a radar transceiver architecture with CDSS correlators and automatic path delay compensation using a group delay filter for radar-to-radar (R2R) interference mitigations, in accordance with an exemplary embodiment of the disclosed technology.

FIG. 9 illustrates a seventh example embodiment of a radar transceiver architecture with RF domain CDSS correlators and time-division path delay compensator for R2R interference mitigations, in accordance with an exemplary embodiment of the disclosed technology.

FIG. 10 illustrates an eighth example embodiment of a radar transceiver architecture with an RF domain CDSS correlator array and path delay compensators for R2R interference mitigations, in accordance with an exemplary embodiment of the disclosed technology.

FIG. 11 is a block diagram illustration of a computing device, in accordance with certain exemplary implementations of the disclosed technology.

FIG. 12 is a flow diagram of a method, in accordance with certain exemplary implementations of the disclosed technology.

FIG. 13 is a flow diagram of a method, in accordance with certain exemplary implementations of the disclosed technology.

### DETAILED DESCRIPTION

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

In accordance with certain exemplary implementations of the disclosed technology, various code-domain spread spectrum (CDSS) techniques may be utilized, for example, to modulate a narrow band signal with a bandwidth of BW_{sig} using a pseudorandom code sequence under a higher chip rate of R_{chip} with the spreading factor (SF) defined as R_{chip}/BW_{sig}. In certain exemplary implementations, the signal may be spread over a bandwidth determined by the Nyquist bandwidth of the coder chip rate, resulting in a spread signal with a power density that is reduced by 10 log 10(SF) dB.

In certain exemplary implementations, a CDSS encoder may be implemented in digital baseband using bandwidth-efficient code modulation schemes can be adopted with proper filtering, leading to more efficient bandwidth utilization for the transmitted spread signal. In accordance with certain exemplary implementations of the disclosed technology, the transceivers disclosed herein may implement the CDSS decoder in the RF domain to achieve unprecedented performance on both in-band jammer rejection and Tx self-interference (SI) suppressions.

Certain implementations of the disclosed technology may be utilized to receive and extract a wanted signal that is companioned by a strong (unwanted) interference signal. In prior designs, the unwanted interference signal may pass through an RF amplifier and cause the gain of the wanted signal to be reduced or even diminished due to the 3rd-order non-linearity of the amplifier. This phenomenon is called receiver desensitization. As a simple example, human eyes can be desensitized by the strong sunlight during the day, losing their sensitivity to detect the stars in the background. To protect the receiver from strong interference, certain implementations of the disclosed technology may directly implement certain CDSS correlators in the RF domain instead of in the baseband. In accordance with certain exemplary implementations of the disclosed technology, CDSS applied in the RF domain may be used to mitigate not only the inter-radio interferences including in-band/out-band and/or R2R jammers but also the inner-radio interferences including TX to RX self-interference (SI).

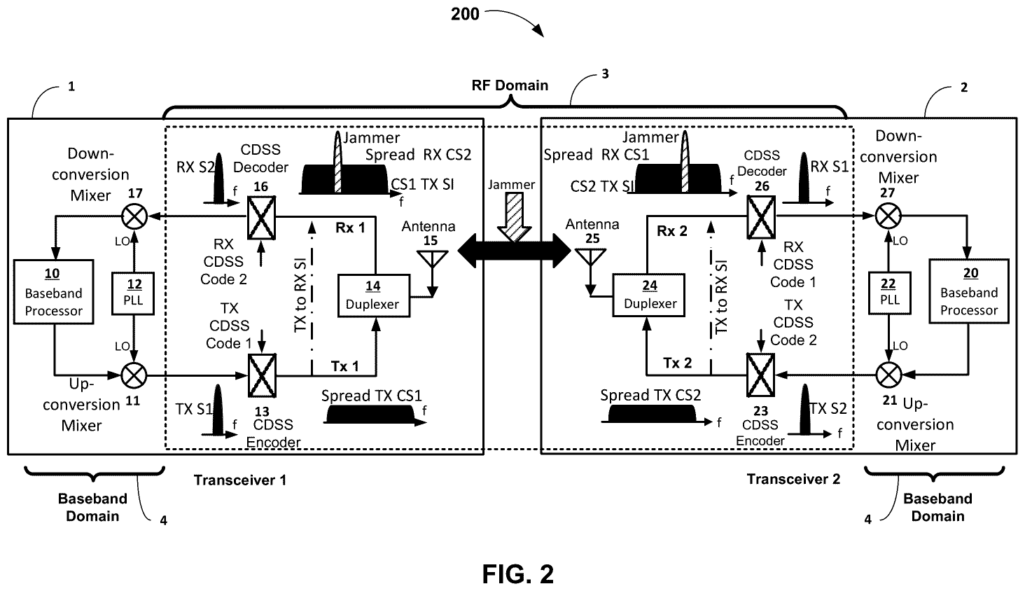

FIG. 2 depicts a conceptual block diagram of a dual transceiver system 200 employing a first communication transceiver 1 and a second communication transceiver 2, each with RF domain sections 3, baseband domain sections 4, and corresponding RF domain CDSS correlators for interference mitigations, in accordance with an exemplary embodiment of the disclosed technology. The system 200 illustrates full-duplexing or simultaneous transmission and receiving (STAR) mode. In this implementation, band-limited signals S1 and S2 may be generated by transceiver baseband processors 10 and 20, and the signals S1 and S2 may be upconverted to the carrier RF frequency generated by phase-locked loops (PLLs) 12 and 22 through up-conversion mixers 11 and 21, respectively. In the RF domain 3, orthogonal codes may be applied on the transmitting waveforms TX S1 and TX S2 through CDSS encoders 13 and 23, respectively. The spread signals TX CS1 and TX CS2 may be fed to the antennae 15 and 25 through duplexers 14 and 24, respectively.

On the receiver paths of the system 200, the received signals are illustrated to include the wanted spread signals from the targeted transmitters, unwanted in-band jammers, and unwanted Tx-to-RX self-interferences. Before reaching the amplifiers and filters on the receiver paths, the received signals may be decoded by CDSS decoders 16 and 26, respectively. The orthogonal code sequences (Code 1 and Code 2) synchronized and correlated with the corresponding Tx encoders 13 and 23 may be applied to the Rx decoder 16 and 26, respectively. Due to the Tx to Rx leakage through the duplexer and other on-chip parasitic paths, the code spread signals (CS1 and CS2) may be leaked to their Rx on the same die with certain attenuation, causing Tx-to-RX self-interferences (SI). Assuming in-band jammers are also present at the inputs of both Rx's front-ends, only the input signals CS1 and CS2 coded with the same orthogonal codes may be decoded and recovered properly to their original narrowband signals (S1 and S2) by the CDSS decoders 16 and 26 placed on the Rx paths, while the jammer and Tx-to-Rx SI signals cannot be decoded or restored, keeping their spread spectra within the wide coding bandwidth with in-band power suppressed by 10 log 10(SF) dB. The code modulation may also randomize the energy of distinct jamming tones, preventing receiver building blocks from being desensitized. Without the disclosed RF domain CDSS technique, the receiver could be saturated by the interferers and may not be able to detect the wanted signal even if the decoding scheme is employed in the baseband.

In accordance with certain exemplary implementations of the disclosed technology, the CDSS Code 1 used in the Tx and the CDSS code 2 used in Rx may be identical but offset in time with one another to eliminate self-interference while providing proper timing synchronization considering the channel delay of the receive signal. In certain exemplary implementations, this time synchronization can be done by inserting a group-delay filter or a phase delay cell in the Rx path. Similarly, the CDSS Code 2 used in the Rx may be identical to the code used in the partner Tx, with timing delay/synchronization between the codes that may be calibrated during the initial channel establishment phase.

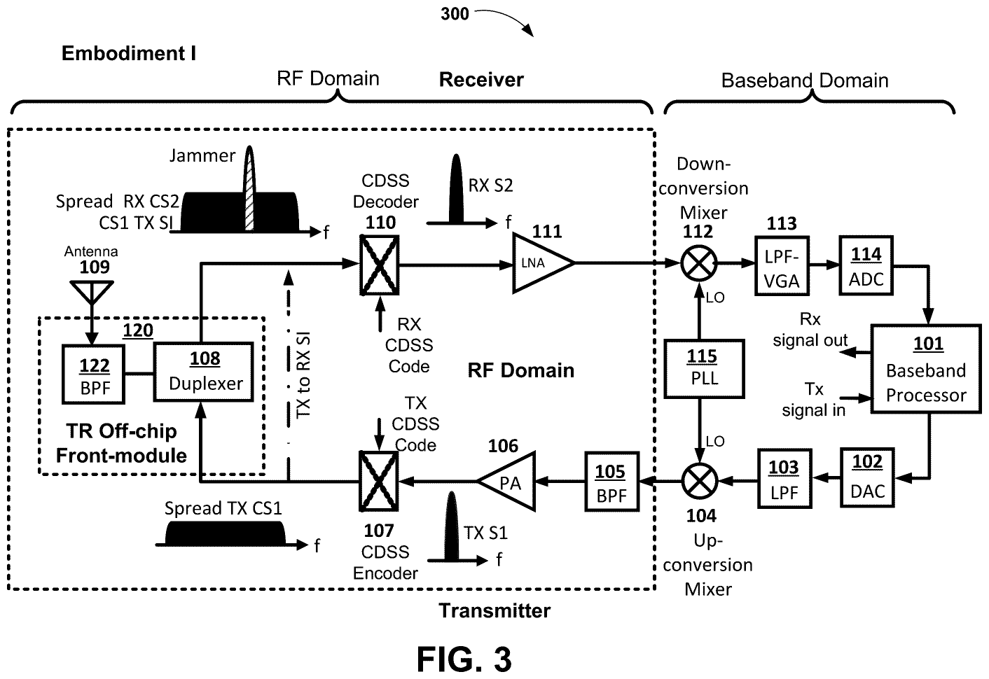

FIG. 3 illustrates a first exemplary embodiment of a transceiver architecture 300 with RF domain CDSS correlators for inter- and inner-radio interference mitigations in accordance with an exemplary embodiment of the disclosed technology. In this example embodiment, a band-limited modulated RF signal may be generated from the transmitter's baseband unit 101 and may be converted to an analog signal by a digital-to-analog converter (DAC) 102. After a low-pass filter 103, the analog signal may be upconverted to the carrier RF frequency generated by a phase-locked loop (PLL) 115 through an up-conversion mixer 104. After a band-pass filter 105, the up-converted signal may be further amplified by the power amplifier (PA) 106. Then, an orthogonal TX CDSS code may be applied to the transmitting waveform on the Tx path by a CDSS encoder 107. The resulting spread signal may be fed to the antenna 109 for transmission via a duplexer 108 and a bandpass filter 122. In this example embodiment, placing the CDSS encoder 107 after the PA 106 may help suppress the self-interferences coupled to the receiver front-end from the coupling sources such as the duplexer 108, which normally has limited Tx-to-Rx isolation.

On the receiver path of the first example embodiment of a transceiver architecture 300, the signal received from the antenna 109 may include a wanted spread signal and unwanted unknown interferers (such as a self-interference signal, a jammer signal, etc.,) For example, the transceiver's 300 own transmitter section may leak strong signal to its receiver's input (and/or associated components) causing self-interference under simultaneous transmission and receiving (STAR) operation or in full duplexing mode.

In accordance with certain exemplary implementations of the disclosed technology, the wanted signal, companioned by external interference as well as self-interference, may be fed to a CDSS decoder 110. By coherent decoding at the receiver front-end, only the desired signal encoded at the Tx using the same orthogonal codes with proper coding synchronization may be decoded and restored by the Rx. All other unwanted interferences such as SI leakage from the Tx to the Rx and any in-band jammers picked by the antenna may be suppressed by spreading their energy over the code modulation bandwidth. The receiver building blocks after the CDSS decoder such as the low-noise amplifier (LNA) 111, the down-conversion mixer 112, and the variable-gain amplifier (VGA)/low-pass filter (LPF) 113 may all be protected from being blocked or swamped by the strong interferers, allowing the receiver to detect only the wanted signal. In certain exemplary implementations, the resulting down-converted signal may have its magnitude adjusted for digitization by an analog-to-digital converter (ADC) 114.

In accordance with certain exemplary implementations of the disclosed technology, the CDSS codes used for decoding the received waveform may be synchronized with the transmitter (not shown) that sends the wanted signal. In certain exemplary implementations, such synchronization may be accomplished through an adaptive delay calibration on the decoding code sequence. In the case of radar transceivers, the decoding codes may be the same as the encoding codes used by their own transmitter. In certain exemplary implementations, the CDSS correlation may be used to mitigate R2R interferences coming from other radars.

This first example embodiment of the transceiver architecture 300 may utilize the CDSS encoder 107 after the PA 106, and the CDSS decoder 110 right before the LNA 111, for example, to provide the advantage of protecting the entire receiver path from interferences. In this implementation, the PA 106 doesn't need to handle the spread-wide bandwidth, which may be much larger than the original signal bandwidth. In certain exemplary implementations, the CDSS encoder 107 and the CDSS decoder 110 may be added in the TR-front-module 120 with the duplexer 108 and SAW filters employed in the bandpass filter 122, which may enable use with a conventional transceiver chip to form a complete TR module for communication and radar systems. However, one drawback of this approach is that the CDSS encoder 107 may need to handle the large signal(s) amplified by the PA 106. Furthermore, the variable impedance during the code-switching may present challenges for Tx output port impedance matching. The CDSS decoder 110 in front of the LNA 111 may introduce certain insertion loss, which can increase the overall noise figure (NF) of the receiver. Therefore, adaptive impedance tuning around the encoder ports in the Tx and the noise canceling schemes around the decoder in the Rx may be utilized, in accordance with certain exemplary implementations of the disclosed technology.

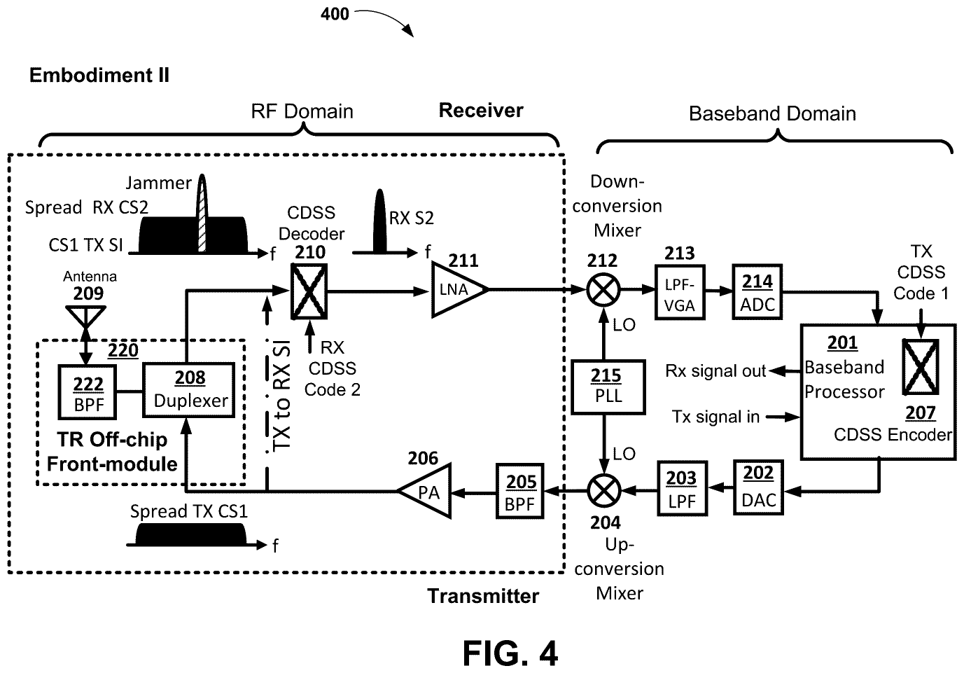

FIG. 4 illustrates a second exemplary embodiment of a transceiver architecture 400 with an RF domain CDSS decoder 210 and a baseband CDSS encoder 207 for inter- and inner-radio interference mitigations in accordance with an exemplary embodiment of the disclosed technology. This second example embodiment of the transceiver architecture 400 may be a preferred embodiment in that it may utilize RF domain decoding and baseband encoding, which can provide several advantages. For example, implementing the CDSS decoder 210 in the RF domain (e.g., before the LNA 211) can provide the advantage of protecting the entire receiver path from interference. Additionally, a number of advantages may be gained via the baseband encoding. For example, this embodiment may: (1) enable the use of more complex modulation schemes for encoding; (2) enable baseband filtering to provide increased bandwidth efficiency; (3) enable sideband filtering of the modulated signal (such as via Gaussian filtered Minimum Shift Keying (GMSK)) to prevent spectral regrowth through the PA 206; (4) reduce the linearity requirements of the PA 206; (5) reduce the impact on the PA 206 input and output impedance matching; (6) enable a higher coding rate; (7) enable a higher spreading factor; (8) enable combining the CDSS encoding with other baseband processing and algorithms; (9) reduce power requirements; (10) increase overall power efficiency (i.e., FoM=spreading factor/power); (11) require less area; etc. Thus, by encoding in baseband (for example, by placing the CDSS encoder 207 in the baseband processor unit 201), many hardware and power overhead requirements may be reduced, and more modulation and/or filtering options may be gained. Digital filtering (in the baseband processor unit 201 or at its output), for example, can also be utilized to achieve improved bandwidth efficiency.

In accordance with certain exemplary implementations of the disclosed technology, the baseband processor unit 201 may receive, as input, a TX signal, which may be encoded by the CDSS encoder 207 and converted to an analog signal by a digital-to-analog converter 202. After a low-pass filter 203, the analog signal may be upconverted to the carrier RF frequency by an up-conversion mixer 204 in communication with a phase lock loop (PLL) 215. In certain exemplary implementations, the resulting upconverted signal may pass through a band-pass filter 205, and the spread signal may be amplified by the power amplifier 206 and fed to the antenna 209 for transmission via a duplexer 208.

On the receiver path of the second exemplary embodiment of a transceiver architecture 400, the signal received from the antenna 209 may include a wanted spread signal and the unknown interferers. In STAR or full duplexing operation, the transceiver's own transmitter may also leak its signal to its receiver's input (or associated components), causing self-interference (SI). The wanted signal, companioned by external interferences as well as SI, may be first fed to a CDSS decoder 210. By coherent decoding at the receiver front-end, only a desired signal encoded at a Tx using the same orthogonal codes with proper coding synchronization may be decoded and restored by the Rx. All other unwanted interferences such as SI leakage from the Tx to the Rx and any in-band jammers picked by the antenna 209 may be suppressed by spreading their energy over the code modulation bandwidth. In certain exemplary implementations, the receiver building blocks after the CDSS decoder 210, such as the low-noise amplifier 211, the down-conversion mixer 212, and the variable-gain amplifier/low-pass filter 213 may be protected from being blocked by the strong interferers, allowing the receiver to detect only the wanted signal and adjust its magnitude for digitization by an analog-to-digital converter 214. In communication systems, the CDSS codes used for decoding the received waveform may be synchronized with a transmitter that sends the wanted signal, which can be done through an adaptive delay calibration of the decoding sequence. In the case of radar transceivers, the decoding codes may be the same as the encoding codes used by their own transmitter. Thus, in certain implementations, the CDSS correlation may be used for R2R interference mitigation.

Since the second example embodiment of the transceiver architecture 400 places the CDSS encoder 207 in the baseband processor unit 201, and since the CDSS decoder 210 is placed right before the LNA 211, this architecture 400 may gain an advantage over other implementations including, but not limited to easy encoder implementation in the digital domain, while protecting the entire receiver path from interferences.

In certain exemplary implementations, the CDSS decoder 210 can be added in the TR-front-module 220 with the duplexer 208 and SAW filters may be used as a bandpass filter 222 to allow use with a conventional transceiver chip to form a complete TR module for communication and radar systems. However, one drawback of this approach is that the decoder 210 in front of the LNA 211 may introduce certain insertion loss, which can increase the overall noise figure of the receiver. In addition, the Tx path may need to handle the spread-wide bandwidth. Therefore, according to certain implementations, wide band Tx design and a noise-canceling scheme at the Rx front-end 220 may be utilized in this implementation of the approach. If increased transmitting bandwidth and elevated receiver sensitivity level can be tolerated, this second example embodiment of the transceiver architecture 400 approach may be the most efficient architecture for interference mitigation through CDSS.

In accordance with certain exemplary implementations of the disclosed technology, the CDSS Code 1 used in the Tx and the CDSS code 2 used in Rx may be identical but offset in time with one another to eliminate self-interference while providing proper timing synchronization considering the channel delay of the receive signal. For example, the CDSS code 2 used in the Rx may be delayed version of CDSS Code 1 used in the Tx. In certain exemplary implementations, this time synchronization can be done by inserting a group-delay filter or a phase delay cell in the Rx path. Similarly, the CDSS Code 2 used in the Rx may be identical to the code used in the partner Tx, with timing delay/synchronization between the codes that may be calibrated during the initial channel establishment phase.

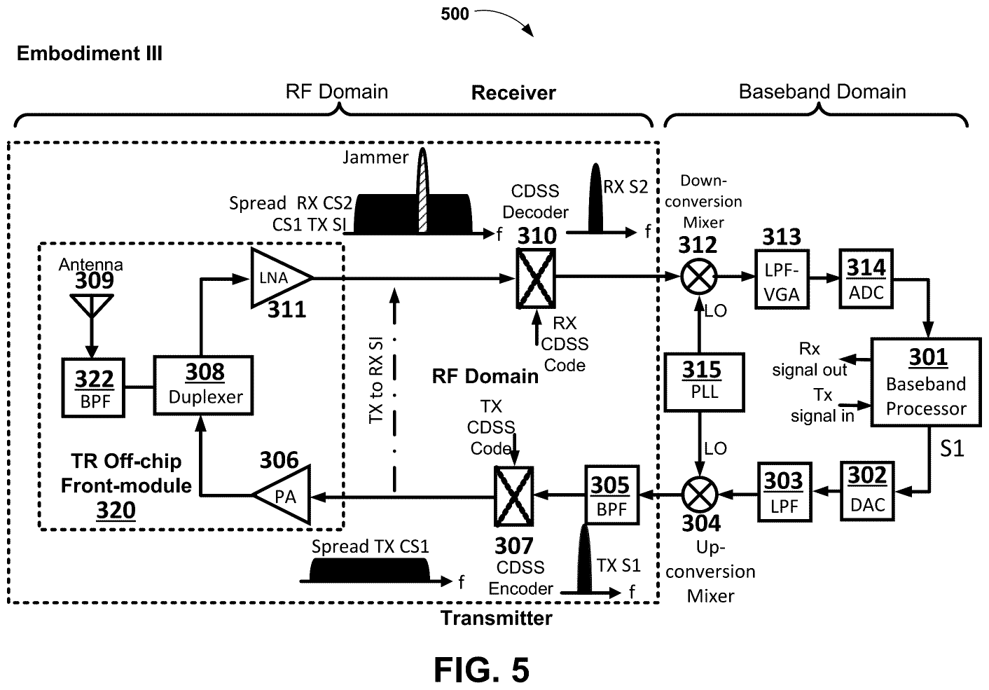

FIG. 5 illustrates a third example embodiment of a transceiver architecture 500 with RF domain CDSS correlators for inter- and inner-radio interference mitigations, in accordance with an exemplary embodiment of the disclosed technology. In this example implementation, a band-limited modulated signal S1 may be generated from the transmitter baseband processor unit 301 responsive to a Tx signal input and converted to an analog signal by a digital-to-analog converter 302. After a low-pass filter 303, the analog signal may be upconverted to the carrier RF frequency by an up-conversion mixer 304, which may be in communication with a phase lock loop (PLL) 315. After a band-pass filter 305, an orthogonal code may be applied to the transmitting signal on the Tx path in the RF domain by a CDSS encoder 307. The resulting spread signal may be amplified by a power amplifier 306 and may be fed to the antenna 309 via a duplexer 308 for transmission. In this example embodiment, placing the CDSS encoder 307 right before the PA 306 may simplify the encoder 307 design since it doesn't need to handle large signals amplified by the PA 306.

On the receiver path, the signal received from the antenna 309 can include a wanted spread signal and unknown interferers. In STAR or full duplexing mode, the transceiver's own transmitter may also leak signal to its receiver's input and/or associated components causing self-interference (SI). The wanted signal, companioned by external interference as well as SI, may be fed to a low noise amplifier (LNA) 311 for amplification. With the gain provided by the LNA 311, the noise requirement for the later stages on the Rx path may be greatly relaxed. A CDSS decoder 310 may be inserted after the LNA 311 and before the down-conversion mixer 312 to perform CDSS decoding. By coherent decoding at the receiver front-end, the desired signal encoded at the Tx using the same orthogonal codes with proper coding synchronization may be decoded and restored by the Rx. All other unwanted interferences such as SI leakage from the Tx to the Rx and any in-band jammers picked by the antenna 309 may be suppressed by spreading their energy over the code modulation bandwidth. The receiver building blocks after the CDSS decoder 310, such as the down-conversion mixer 312, and the variable-gain amplifier/low-pass filter 313 may be protected from being blocked by strong interferers, allowing the receiver to detect the wanted signal and adjust its magnitude for digitization by an analog-to-digital converter 314.

In accordance with certain exemplary implementations of the disclosed technology, this third exemplary embodiment of a transceiver architecture 500 may utilize the CDSS encoder 307 before the PA 306, and the CDSS decoder 310 may be placed right after the LNA 311 to provide the advantages of protecting the receiver path (except the LNA 311) from interferences and may allow relaxing the CDSS encoder 307 in the Tx since it doesn't need to handle large signal amplified by the PA 306. With the gain provided by the LNA 311, the decoder's 310 noise requirement may be relaxed or eliminated. However, the drawback of this approach is that the PA 306 may need to handle spread bandwidth and the LNA 311 may not be protected from interference. Therefore, according to certain exemplary implementations, a wideband PA 306 may be used in the Tx and the LNA 311 in the Rx may have a high linearity. This approach is particularly useful if the LNA 311 and the PA 306 are partitioned off-chip in a separate front-end module 320, which can include the duplexer 308 and the bandpass filter 322 in communication with the antenna 309. In such example implementations, the decoder 310 and encoder 307 may serve as the first stage of the Rx and the last stage of the Tx in a conventional transceiver, protecting the receiver path from interference.

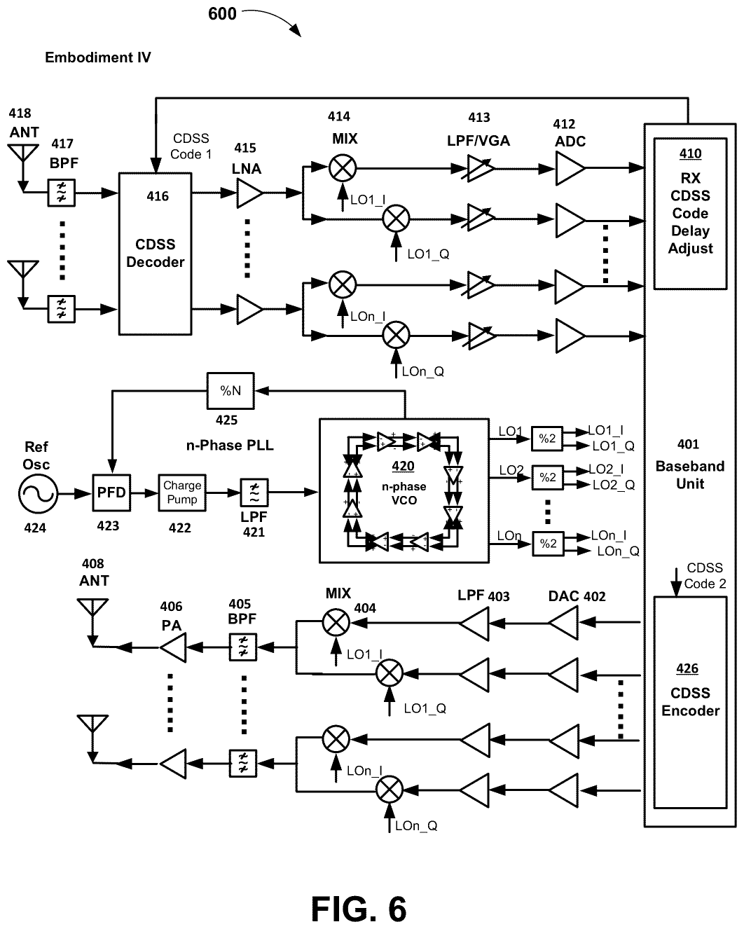

FIG. 6 illustrates a fourth example embodiment of a MIMO or phased array transceiver architecture 600 with RF domain CDSS correlators for inter- and inner-radio interference mitigations, in accordance with an exemplary embodiment of the disclosed technology. In this example architecture 600, multiple receiver and transmitter paths may be combined to achieve multiple-input-multiple-output (MIMO) or phased array operation. In certain exemplary implementations, the CDSS encoder 426 can be implemented in the baseband unit 401. In certain exemplary implementations, the CDSS coding scheme can be combined with the MIMO algorithm to achieve a unique waveform coding scheme by adding spatial diversity provided by the MIMO paths.

In accordance with certain exemplary implementations of the disclosed technology, the coded and modulated waveform signals may be converted to analog signals by digital-to-analog converters 402. After low-pass filters 403, the in-phase (I) and quadrature-phase (Q) analog signals may be upconverted to the carrier RF frequency by quadrature up-conversion mixers 404. After band-pass filters 405, the spread signals modulated on the RF carrier may be amplified by the power amplifiers 406 and may be fed to the antenna array 408 for transmission. In this example implementation, placing the CDSS encoder 426 in the baseband unit 401 may require less hardware overhead and may be the most convenient way to code any transmitted waveforms with complex modulation and filter schemes.

On the receiver path of the architecture 600, the signal received from the MIMO or phased array antenna array 418 may include the wanted spread signals and the unknown interferers. In STAR or full duplexing mode, the transceiver's own transmitter may also leak a signal to its receiver's input, causing self-interference. The wanted signals, companioned by external interference as well as self-interference, may be first fed to CDSS decoders 416. By coherent decoding at the receiver front-end, only the desired signals encoded using the same orthogonal codes with proper coding synchronization (for example, via the RX CDSS code delay adjuster 410) may be decoded and restored by the Rx. All other unwanted interferences such as SI leakage from the Tx to the Rx and any in-band jammers picked by the antennae 418 may be suppressed by spreading their energy over the code modulation bandwidth. In certain exemplary implementations, the receiver building blocks after the CDSS decoders 416, such as the low-noise amplifiers 415, the down-conversion mixers 414, and the variable-gain amplifiers/low-pass filters 413 may be protected from being blocked by the strong interferers, allowing the receiver to detect only the wanted signals and adjust their magnitudes to the full-scales of the analog-to-digital converters 412 for digitization. In communication systems, the CDSS codes used for decoding the received waveform may be synchronized with a transmitter that sends the wanted signal, which can be done through a delay calibration loop to adaptively adjust the decoding sequence's timing. In the case of radar transceivers, the decoding codes may be the same as the encoding codes used by their own transmitter. Thus, the CDSS correlation in radar applications may be employed for R2R interference mitigation.

In accordance with certain exemplary implementations of the disclosed technology, the multi-phase local oscillation (LO) signals needed for MIMO or phased array operation can be generated through a multi-phase PLL including an n-phase VCO 420, a loop low pass filter 421, a charge pump 422, a phase-frequency detector 421, a reference oscillator 424 and a loop divider 425.

In accordance with certain exemplary implementations of the disclosed technology, this fourth exemplary embodiment of a MIMO or phased array transceiver architecture 600 may utilize the encoder 400 in the baseband digital unit 401, and the decoders 416 may be configured right before the LNAs 415 to provide certain advantages, such as easy encoder implementation in the digital domain while protecting the entire receiver path including the LNA from interferences. In certain exemplary implementations, the CDSS correlation algorithm can be combined with MIMO or phase array algorithms to achieve additional benefits from spatial diversity provided by the antenna arrays. However, one drawback of this approach is that the decoders in front of the LNAs may introduce certain insertion loss, which can increase the overall noise figure (NF) of the receiver. In addition, the entire Tx paths may need to handle the spread-wide bandwidth. Therefore, in accordance with certain exemplary implementations of the disclosed technology, a wide band Tx design and noise-canceling front-end design for the Rx may be utilized to implement this approach. Furthermore, MIMO operations may be utilized to improve the bit-error rate (BER) or error vector magnitude (EVM) in a communication TRx or range/angular resolutions in a radar TRx. In applications that require increased transmitting bandwidth, and if the elevated receiver sensitivity level and the hardware complexity for MIMO operation can be tolerated, this example architecture 600 may be the most efficient and high-performance solution for interference mitigation through CDSS.

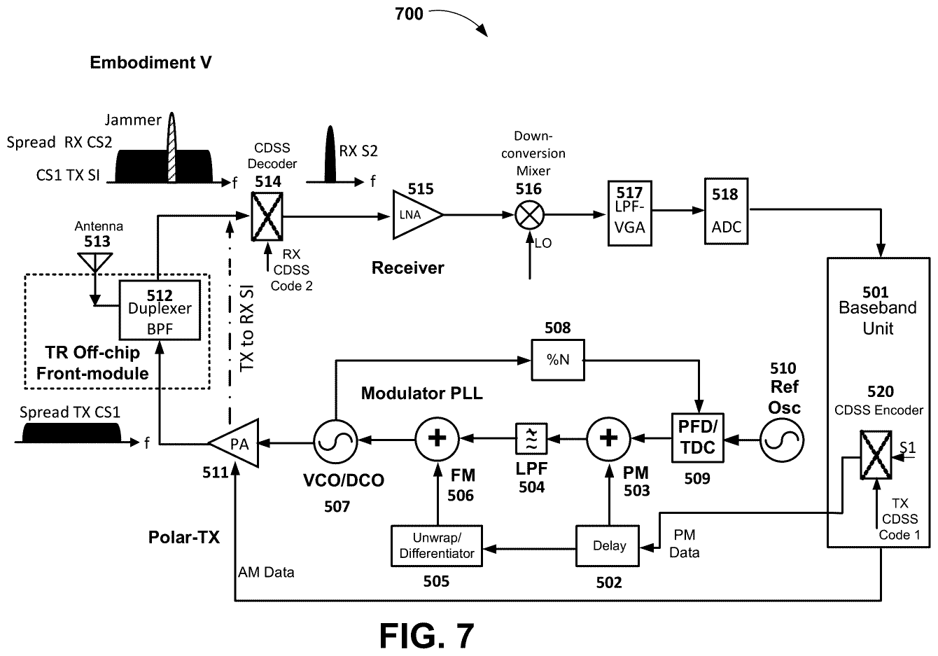

FIG. 7 illustrates a fifth example embodiment of a polar transceiver architecture 700 with RF domain CDSS correlators for inter- and inner-radio interference mitigations in accordance with an exemplary embodiment of the disclosed technology, where a band-limited modulated signal S1 may be generated from the transmitter baseband unit 501 and may be encoded with orthogonal TX CDSS Code 1 through an encoder 520 implemented in the baseband unit 501.

In certain exemplary implementations, the architecture 700 may utilize a PLL modulator using a two-point-injection modulation scheme, where phase data (PM) may be fed to the phase modulation point 503 and frequency modulation point 506 of the PLL loop, respectively. In certain exemplary implementations, delay 502, unwrap 505 and gain adjustments may be utilized to balance the PM and FM data to achieve desired flat modulation response over a wide bandwidth. At the VCO 507 output, the phase data may be modulated directly onto the carrier frequency generated by the PLL. In certain exemplary implementations, amplitude modulation can be implemented by modulating the supply voltage or bias current of the PA 511.

According to an exemplary implementation of the disclosed technology, the transmitting signal may be fed to the antenna 513 via a duplexer/BPF 512 for transmission. In certain exemplary implementations, the polar transmitter can achieve high efficiency by dealing with PM and AM separately. The CDSS coding in baseband may add minimal hardware overhead, and the two-point-injection modulation scheme may help boost the modulation bandwidth beyond the loop bandwidth limit.

On the receiver path, and in accordance with certain exemplary implementations of the disclosed technology, the receive signal received from the antenna 513 can include wanted spread signal, unknown interferers, and self-interference (SI) from its own transmitter. The wanted signal, companioned by external interferences and/or SI, may be fed to a CDSS decoder 514. By coherent decoding at the receiver front-end, only the desired signal encoded at a Tx using the same orthogonal codes with proper coding synchronization may be decoded and restored by the Rx. All other unwanted interferences such as SI leakage from the Tx to the Rx and any in-band jammers picked up by the antenna may be suppressed by spreading their energy over the code modulation bandwidth. The receiver building blocks after the CDSS decoder such as the low-noise amplifier 515, the down-conversion mixer 516, and the variable-gain amplifier/low-pass filter 517 may be protected from being blocked by the strong interferers, allowing the receiver to detect only the wanted signal and adjust its magnitude for digitization by an analog-to-digital converter 518. In communication systems, the CDSS codes used for decoding the received waveform may be synchronized with the transmitter that sends the wanted signal, which can be done through an adaptive delay calibration on the decoding sequence. In the case of radar transceivers, the decoding codes may be the same as the encoding codes used by their own transmitter. Thus, the CDSS correlation may be used for R2R interference mitigation.

In accordance with certain exemplary implementations of the disclosed technology, this fifth example embodiment of a polar transceiver architecture 700 may utilize the CDSS encoder 501 in the baseband, and the transmitter may be implemented as a polar TX using the modulator PLL for PM and a PA 511 for AM. This architecture 700 of a polar transmitter that utilizes the CDSS encoder 501 in baseband may simplify the encoder design and may improve the transmitter efficiency. In certain exemplary implementations, the TX required power and area may also be reduced by eliminating the building blocks such as a DAC, an LPF, and the up-conversion mixer as used on a traditional TX path. For the RX path, the CDSS decoder 514 may be placed in front of the LNA 515 to protect the entire receiver (including the LNA 515) from interferences. However, one drawback of this approach is that the PLL modulator normally has limited modulation bandwidth even if the two-point injection or predistortion scheme is employed. Furthermore, the PA 511 may need to handle AM while performing PM signal amplification. Synchronization of PM and AM data may be calibrated against process-voltage-temperature (PVT) variations.

Since the received signal comes with a propagation delay with respect to the transmitted signal, the CDSS code used for decoding needs to be properly delayed in order to compensate the channel delay. For communication transceivers, the channel delay can be calibrated during the initial hand-shaking or idle time. For radar applications, synchronization between the encoder and the decoder is not trivial, especially when multiple targets are involved. Proper delay can be applied to decoding code by radar baseband to compensate the path delay. However, when multiple targets at different distances need to be detected, tunable delays may be employed (similar to adjusting a lens focal length for a camera in order to obtain a clear image of the desired target). The following embodiments illustrates a few remedies for compensating the channel delays in radar transceivers. The embodiments illustrated in this disclosure should not be considered to limit the scope of the disclosed technology.

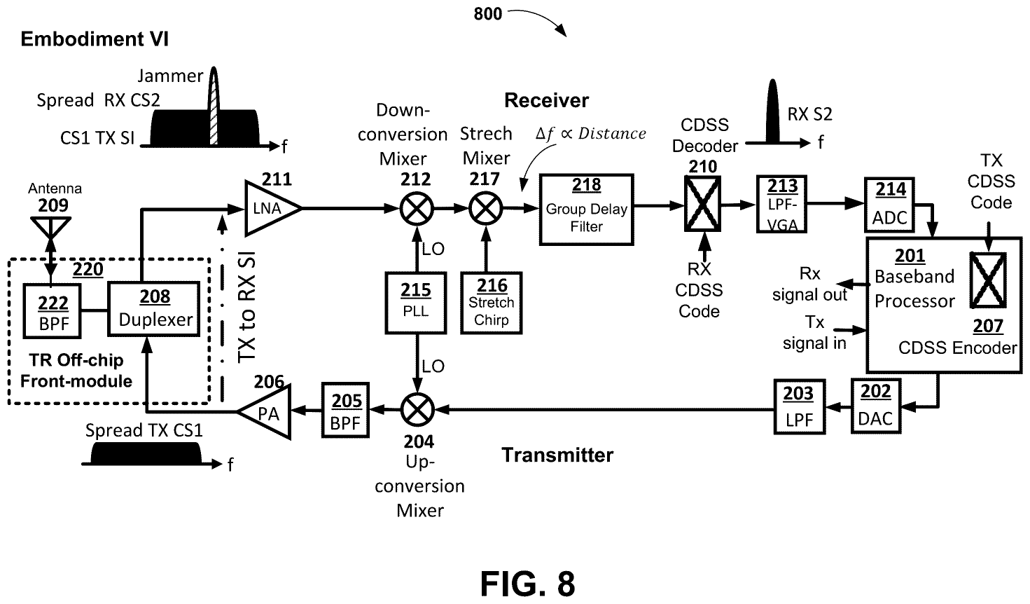

FIG. 8 illustrates a sixth example embodiment of a radar transceiver architecture 800 with CDSS correlators and automatic path delay compensation using a group delay filter 218 for radar-to-radar (R2R) interference mitigations, in accordance with an exemplary embodiment of the disclosed technology. Certain components this architecture 800 may be the same or similar to those having the same reference numerals as discussed above with respect to the architecture 400 of FIG. 4. In the embodiment shown in FIG. 8, the received signal may first be downconverted by a down-conversion mixer 212 to an inter-median frequency (IF) followed by a stretching processes that, in certain implementations, may be implemented by driving a (stretch) mixer 217 with a (stretch) chirp waveform 216. For example, a receivinglinear frequency modulated (LFM, i.e., a chirp) waveform may be mixed with a second LFM (stretch) waveform to produce an output of the stretch mixer 217. The frequency difference Δf=fᵣₓ−f_{strech} obtained at the output of the stretch mixer 217 is proportional to the distance information and thus may enable proper delay for targets of interest. A group delay filter 218 may follow the stretch mixer 216 to impose frequency/distance dependent phase delays to compensate for the signal path delay. As a result, the waveform after the group delay filter 218 may not have the phase variation caused by targets' distances. After the group-delay filter 218, a CDSS decoder 210 may be used to decode the waveforms reflected by the targets in variety of distances.

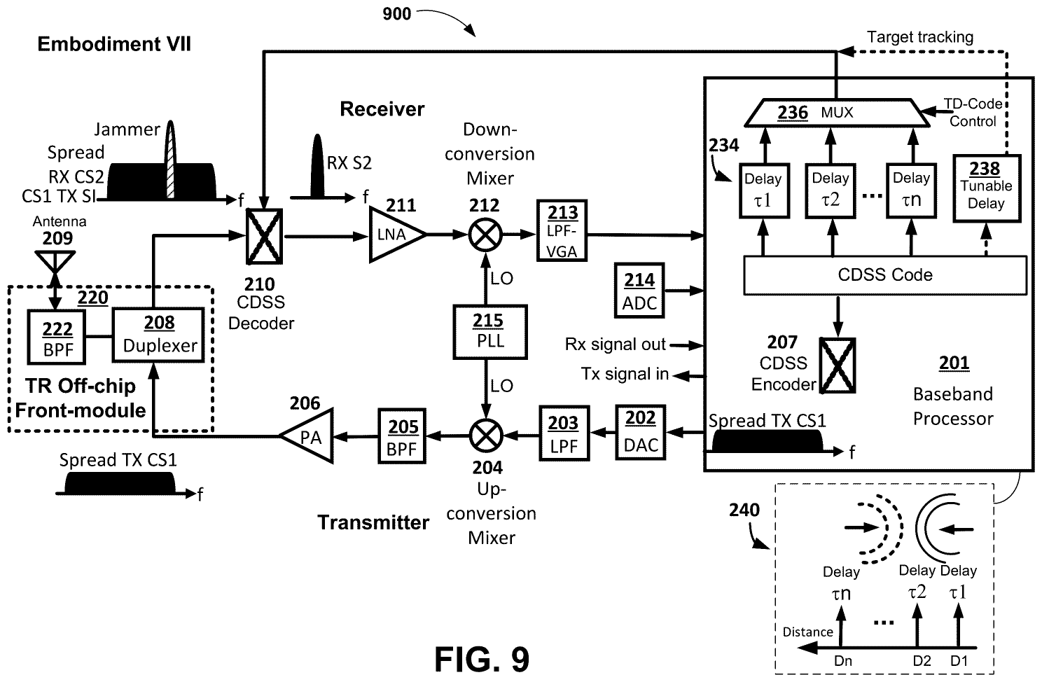

FIG. 9 illustrates a seventh example embodiment of a radar transceiver architecture 900 with RF domain CDSS correlators and time-division path delay compensators 234 238 for R2R interference mitigations in accordance with an exemplary embodiment of the disclosed technology. Certain components this architecture 900 may be the same or similar to those having the same reference numerals as discussed above with respect to the architecture 800 of FIG. 8 and/or the architecture 400 of FIG. 4. In this embodiment shown in FIG. 9, a detection range may be split into a few sub-ranges with their mean path delays, such as τ1, τ2 and τn, as illustrated in the inset FIG. 240. Assuming the decoder can tolerate the distance variations within the sub-distance range, mean delays 234 can be applied to the decoding code sequence in a time-division (TD) manner, for example, via a multiplexer 236 at a fraction of coding period. In certain exemplary implementations, a particular delay may be added to the decoding code in order to recover the signal reflected by the targets located in the corresponding sub-distance range. Due to the timing mismatch, signals reflected by targets located in other sub-distance ranges will be spread as noise over the coding bandwidth. The radar baseband processor 201 can also lock the decoder 210 to a specific target (via delay 234 selection) that is of the most interest to the application. In certain exemplary implementations, a tunable delay 238 may be utilized and applied to the decoder 210, for example, and adaptively tuned to track the distance of a target of interest, such as a fast-approaching car.

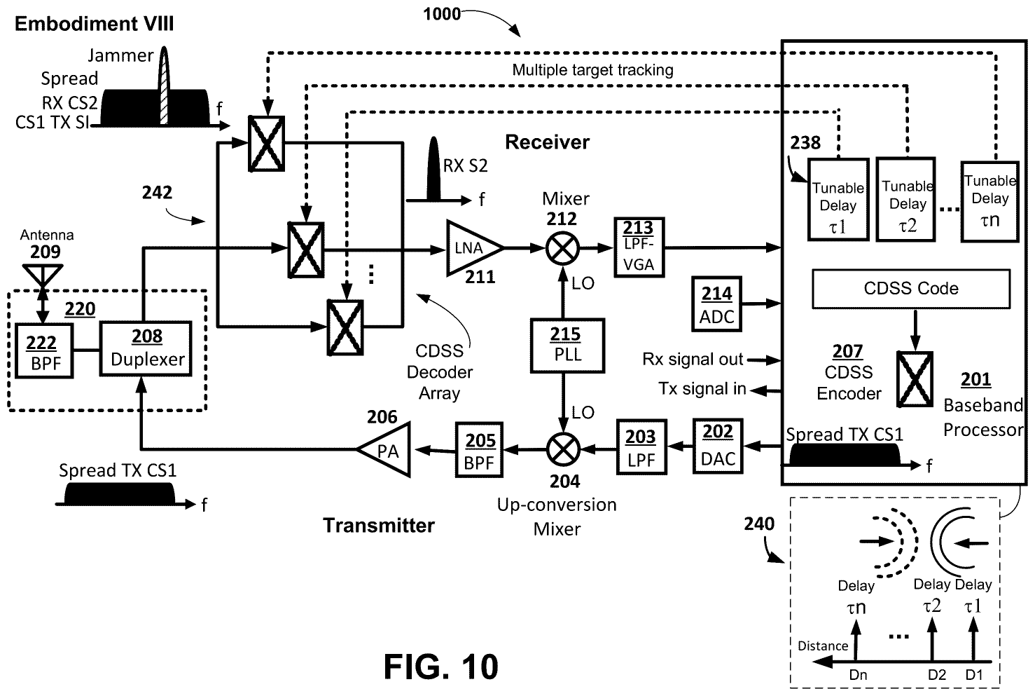

FIG. 10 illustrates an eighth example embodiment of a radar transceiver architecture 1000 with RF domain CDSS correlator array 242 and path delay compensators 238 for R2R interference mitigations in accordance with an exemplary embodiment of the disclosed technology. Certain components this architecture 1000 may be the same or similar to those having the same reference numerals as discussed above with respect to architecture 900 of FIG. 9 and/or architecture 800 of FIG. 8 and/or the architecture 400 of FIG. 4. In this embodiment shown in FIG. 10 an array 242 of the decoders can be used simultaneously with each decoding code delayed properly to compensate the path delay in each sub-distance range. In certain exemplary implementations, the outputs of all the decoders in the array 242 may be combined to provide a merged waveform with the information for the entire distance range. This is similar to using multiple cameras to focus on different distances and merge the obtained pictures into a high-dynamic picture with very good focal depth. In accordance with certain exemplary implementations of the disclosed technology, the decoder array 242 may be used to track the targets at different distances, providing clear radar images for a wide detection range.

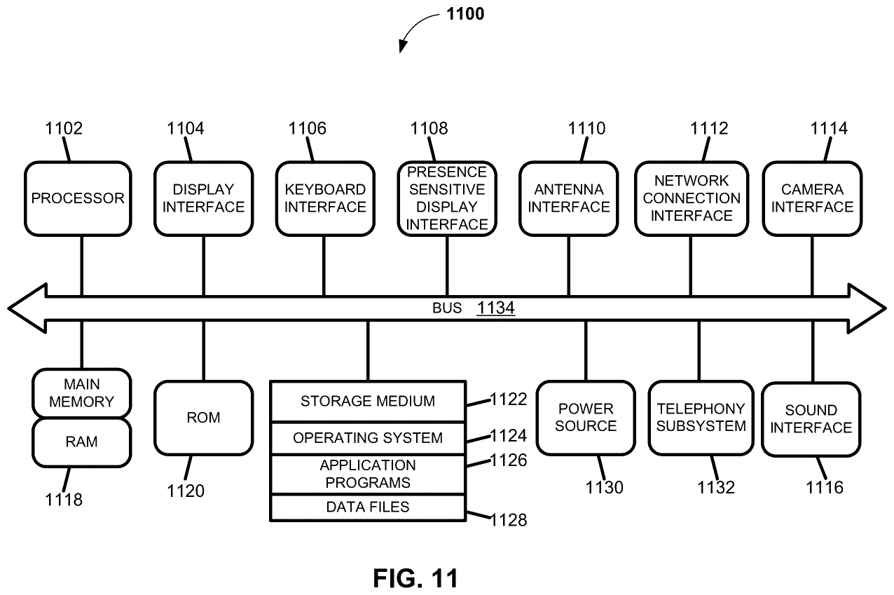

FIG. 11 is a block diagram illustration of a computing device 1100, in accordance with certain exemplary implementations of the disclosed technology, that may be utilized to enable certain aspects of the disclosed technology. Various implementations and methods herein may be embodied in non-transitory computer-readable media for execution by a processor. It will be understood that the computing device 1100 is provided for example purposes only and does not limit the scope of the various implementations of the communication systems and methods.

The computing device 1100 of FIG. 11 includes one or more processors where computer instructions are processed. The computing device 1100 may comprise the processor 1102, or it may be combined with one or more additional components shown in FIG. 11. In some instances, a computing device may be a processor, controller, or central processing unit (CPU). In yet other instances, a computing device may be a set of hardware components.

The computing device 1100 may include a display interface 1104 that acts as a communication interface and provides functions for rendering video, graphics, images, and texts on the display. In certain example implementations of the disclosed technology, the display interface 1104 may be directly connected to a local display. In another example implementation, the display interface 1104 may be configured for providing data, images, and other information for an external/remote display. In certain example implementations, the display interface 1104 may wirelessly communicate, for example, via a Wi-Fi channel or other available network connection interface 1112 to the external/remote display.

In an example implementation, the network connection interface 1112 may be configured as a communication interface and may provide functions for rendering video, graphics, images, text, other information, or any combination thereof on the display. In one example, a communication interface may include a serial port, a parallel port, a general-purpose input and output (GPIO) port, a game port, a universal serial bus (USB), a micro-USB port, a high-definition multimedia (HDMI) port, a video port, an audio port, a Bluetooth port, a near-field communication (NFC) port, another like communication interface, or any combination thereof. In one example, the display interface 1104 may be operatively coupled to a local display. In another example, the display interface 1104 may wirelessly communicate, for example, via the network connection interface 1112 such as a Wi-Fi transceiver to the external/remote display.

The computing device 1100 may include a keyboard interface 1106 that provides a communication interface to a keyboard. According to certain example implementations of the disclosed technology, the presence-sensitive display interface 1108 may provide a communication interface to various devices such as a pointing device, a touch screen, etc.

The computing device 1100 may be configured to use an input device via one or more of the input/output interfaces (for example, the keyboard interface 1106, the display interface 1104, the presence-sensitive display interface 1108, the network connection interface 1112, camera interface 1114, sound interface 1116, etc.,) to allow a user to capture information into the computing device 1100. The input device may include a mouse, a trackball, a directional pad, a trackpad, a touch-verified trackpad, a presence-sensitive trackpad, a presence-sensitive display, a scroll wheel, a digital camera, a digital video camera, a web camera, a microphone, a sensor, a smartcard, and the like. Additionally, the input device may be integrated with the computing device 1100 or may be a separate device. For example, the input device may be an accelerometer, a magnetometer, a digital camera, a microphone, and an optical sensor.

Example implementations of the computing device 1100 may include an antenna interface 1110 that provides a communication interface to an antenna; a network connection interface 1112 that provides a communication interface to a network. According to certain example implementations, the antenna interface 1110 may utilize to communicate with a Bluetooth transceiver.

In certain implementations, a camera interface 1114 may be provided that acts as a communication interface and provides functions for capturing digital images from a camera. In certain implementations, a sound interface 1116 is provided as a communication interface for converting sound into electrical signals using a microphone and for converting electrical signals into sound using a speaker. According to example implementations, random-access memory (RAM) 1118 is provided, where computer instructions and data may be stored in a volatile memory device for processing by the CPU 1102.

According to an example implementation, the computing device 1100 includes a read-only memory (ROM) 1120 where invariant low-level system code or data for basic system functions such as basic input and output (I/O), startup, or reception of keystrokes from a keyboard are stored in a non-volatile memory device. According to an example implementation, the computing device 1100 includes a storage medium 1122 or other suitable types of memory (e.g. such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files include an operating system 1124, application programs 1126 (including, for example, a web browser application, a widget or gadget engine, and or other applications, as necessary) and data files 1128 are stored. According to an example implementation, the computing device 1100 includes a power source 1130 that provides an appropriate alternating current (AC) or direct current (DC) to power components. According to an example implementation, the computing device 1100 includes a telephony subsystem 1132 that allows the device 1100 to transmit and receive sound over a telephone network. The constituent devices and the CPU 1102 communicate with each other over a bus 1134.

In accordance with an example implementation, the CPU 1102 has an appropriate structure to be a computer processor. In one arrangement, the computer CPU 1102 may include more than one processing unit. The RAM 1118 interfaces with the computer bus 1134 to provide quick RAM storage to the CPU 1102 during the execution of software programs such as the operating system application programs, and device drivers. More specifically, the CPU 1102 loads computer-executable process steps from the storage medium 1122 or other media into a field of the RAM 1118 to execute software programs. Data may be stored in the RAM 1118, where the data may be accessed by the computer CPU 1102 during execution. In one example configuration, the device 1100 includes at least 128 MB of RAM, and 256 MB of flash memory.

The storage medium 1122 itself may include a number of physical drive units, such as a redundant array of independent disks (RAID), a floppy disk drive, a flash memory, a USB flash drive, an external hard disk drive, a thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer-readable storage media allow the device 1100 to access computer-executable process steps, application programs, and the like, stored on removable and non-removable memory media, to off-load data from the device 1100 or to upload data onto the device 1100. A computer program product, such as one utilizing a communication system may be tangibly embodied in storage medium 1122, which may comprise a machine-readable storage medium.

According to one example implementation, the term computing device, as used herein, may be a CPU, or conceptualized as a CPU (for example, the CPU 1102 of FIG. 11). In this example implementation, the computing device (CPU) may be coupled, connected, and/or in communication with one or more peripheral devices.

It should also be understood by one skilled in the art that certain devices depicted in FIGS. 2 through 10 may be implemented on a computing device 1100 such as is shown in FIG. 11

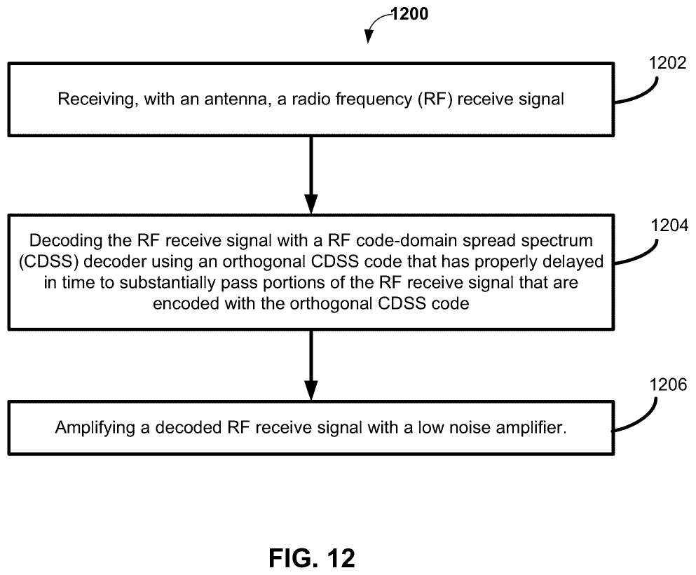

FIG. 12 is a flow diagram of a method 1200, for decoding a received signal in the RF domain, in accordance with certain exemplary implementations of the disclosed technology. In block 1202, the method 1200 includes receiving, with an antenna, a radio frequency (RF) receive signal. In block 1204, the method 1200 includes decoding the RF receive signal with a RF code-domain spread spectrum (CDSS) decoder using an orthogonal CDSS code to substantially pass portions of the RF receive signal that is encoded with the orthogonal CDSS code. In block 1206, the method 1200 includes amplifying a decoded RF receive signal with a low noise amplifier.

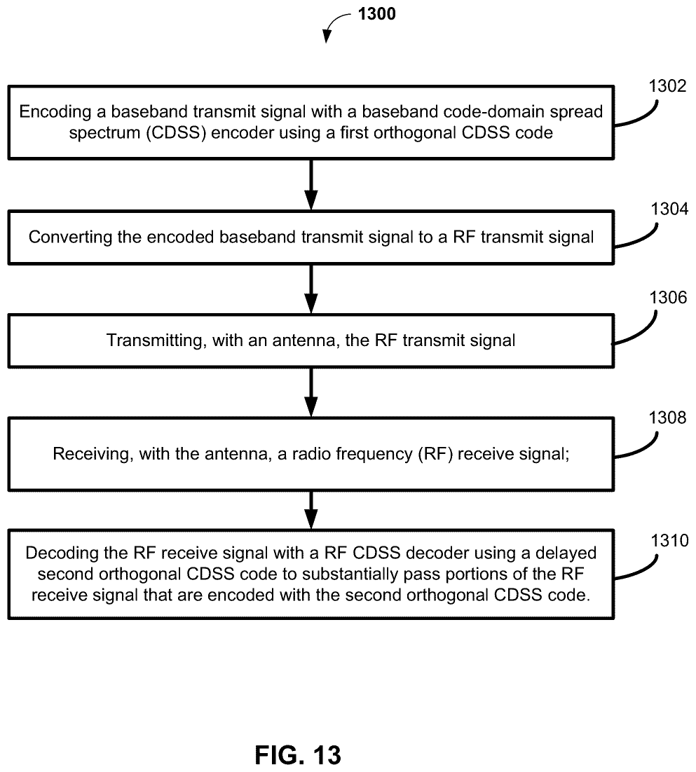

FIG. 13 is a flow diagram of a method 1300 for encoding a transmit signal in a baseband and receiving and filtering an RF signal in the RF domain. In block 1302, the method 1300 includes encoding a baseband transmit signal with a baseband CDSS encoder using a first orthogonal CDSS code. In block 1304, the method 1300 includes converting the encoded baseband transmit signal to an RF transmit signal. In block 1306, the method 1300 includes transmitting, with an antenna, the RF transmit signal. In block 1308, the method 1300 includes receiving, with the antenna, an RF receive signal. In block 1310, the method 1300 includes decoding the RF receive signal with an RF CDSS decoder using a second orthogonal CDSS code to substantially pass portions of the RF receive signal that is encoded with the second orthogonal CDSS code.

Certain implementations may further include duplexing, with a duplexer, the RF receive signal to select and pass the RF receive signal to the RF CDSS decoder.

In certain exemplary implementations, the RF CDSS decoder may be implemented within the duplexer.

Certain exemplary implementations of the disclosed technology can include amplifying the decoded RF signal with an LNA. In certain exemplary implementations, the RF CDSS decoder may be implemented after the duplexer and before the LNA.

Certain exemplary implementations of the disclosed technology may be utilized to substantially block portions of the RF receive signal that is not encoded with the second orthogonal CDSS code using the RF CDSS decoder.

Certain exemplary implementations of the disclosed technology can include amplifying the decoded RF signal with an LNA. According to an exemplary implementation of the disclosed technology, the RF CDSS decoder can include one or more of an impedance tuner, a butterfly switch; and/or a cascode stage in the LNA.

According to an exemplary implementation of the disclosed technology, the antenna can include one or more of a polarized antennae configured for RF domain CDSS decoding and/or a multiple-input-multiple-output (MIMO) or phase array antennae with spatial diversity for CDSS decoding.

Certain exemplary implementations of the disclosed technology can include down-converting the decoded RF receive signal to produce a down-converted signal, digitizing the down-converted signal to produce a digitized down-converted signal, and outputting the digitized down-converted signal.

Certain exemplary implementations of the disclosed technology can include applying variable gain amplification to the down-converted signal.

In accordance with an exemplary implementation of the disclosed technology, the first and second orthogonal CDSS codes may be the same code but delayed or offset in time with respect to one another via calibration to avoid self-interferences.

Certain exemplary implementations of the disclosed technology can include synchronizing the receiving code with the transmitting code to compensate for a signal path delay.

Certain exemplary implementations of the disclosed technology can include downconverting the RF receive signal to an IF frequency signal, processing the IF frequency signal using stretch chirp signal to compensate for a signal path delay; and applying a group delay filter to the processed IF frequency signal. In certain exemplary implementations, the stretch chirp signal can be derived using a first linear frequency modulated (LFM) waveform mixed with a second LFM waveform.

In certain exemplary implementations, the second orthogonal CDSS code may be delayed using one or more time-division path delay compensators having mean delays corresponding to a sub-distance range. In certain exemplary implementations, the delayed second orthogonal CDSS code may be applied to the CDSS decoder in a time-division manner to recover signals reflected by targets located in the sub-distance ranges.

Certain exemplary implementations of the disclosed technology may include locking the CDSS decoder to a specific target by applying to the second orthogonal CDSS code, a tunable delay that is adaptively configured to track the specific target over a variable distance.

In certain exemplary implementations, the RF CDSS decoder can include a plurality of CDSS decoders. In certain exemplary implementations, the plurality of CDSS decoders may have their outputs combined. In certain exemplary implementations, the delayed second orthogonal CDSS code can include a corresponding plurality of selectively delayed second orthogonal CDSS codes that may be delayed by using a corresponding plurality of path delay compensators. In certain exemplary implementations, the second orthogonal CDSS codes may be selectively delayed to compensate for path delay to track targets at different distances.

In accordance with certain exemplary implementations of the disclosed technology, one or more RF domain CDSS correlators and corresponding time-division path delay compensators having mean delays corresponding to a sub-distance range may be applied to the decoding code sequence via the CDSS decoder, for example, in a time-division manner, to recover a signal reflected by one or more targets located in the sub-distance range. In certain exemplary implementations, the radar baseband may also be configured to lock the decoder to a specific target by applying a tunable delay to decoding code that is adaptively tuned to track the distance of the target.

Certain exemplary implementations of the disclosed technology may include an RF domain CDSS correlator array with path delay compensators, in which each decoding code may be delayed properly to compensate for a path delay in each sub-distance range. In certain exemplary implementations, the outputs of all the decoders may combined to provide a merged waveform with the information for the entire distance range. In certain exemplary implementations, the decoder array may be used to track targets at different distances, providing clear radar images for a wide detection range.

Implementations of the subject matter and the functional operations described herein may be implemented in various systems, digital electronic circuitry, or in computer software, firmware, or hardware, including the structures disclosed herein and their structural equivalents, or in combinations of one or more of them. Implementations of the subject matter described herein can be implemented as one or more computer program products, i.e., one or more modules of computer program instructions encoded on a tangible and non-transitory computer-readable medium for execution by, or to control the operation of, data processing apparatus. The computer-readable medium can be a machine-readable storage device, a machine-readable storage substrate, a memory device, a composition of matter affecting a machine-readable propagated signal, or a combination of one or more of them. The term “data processing unit” or “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or another unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flow described in this specification can be performed by one or more programmable processors executing one or more computer programs to perform functions by operating on input data and generating output. The processes and logic flows can also be performed by, and apparatus can also be implemented as, special purpose logic circuitry, e.g., FPGA (field programmable gate array) or ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory, or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Computer-readable media suitable for storing computer program instructions and data include all forms of non-volatile memory, media, and memory devices, including by way of example semiconductor memory devices, e.g., EPROM, EEPROM, flash memory devices. The processor and the memory can be supplemented by, or incorporated into, special-purpose logic circuitry.

While this disclosure includes many specifics, these should not be construed as limitations on the scope of any invention or of what may be claimed, but rather as descriptions of features that may be specific to particular embodiments of particular inventions. Certain features that are described in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described herein should not be understood as requiring such separation in all embodiments.

The detailed description and accompanying figures may allow quick ascertain of the disclosed technology but should not be used to limit the scope or meaning of the claims. In the foregoing, various features are grouped together in various embodiments for the purpose of streamlining the disclosure. The organization of the disclosure is not intended to show that the claimed embodiments require more features than are expressly recited in each claim. Rather, as the following claims reflect, the subject matter may include less than all features of a single disclosed embodiment. Thus, the following claims are hereby incorporated herein, with each claim standing on its own as a separately claimed subject matter.

While the disclosed technology has been taught with specific reference to the above embodiments, a person having ordinary skill in the art will recognize that changes can be made in form and detail without departing from the spirit and the scope of the disclosed technology. The described embodiments are to be considered in all respects only as illustrative and not restrictive. All changes that come within the meaning and range of equivalency of the claims are to be embraced within their scope. Combinations of any of the methods and apparatuses described hereinabove are also contemplated and within the scope of the disclosed technology.

1. A transceiver comprising:
a duplexer in communication with an antenna, the antenna configured to:
transmit a radio frequency (RF) transmit signal; and
receive a RF receive signal;
a transmitter in communication with the duplexer, the transmitter comprising:
a baseband code-domain spread spectrum (CDSS) encoder configured encode a baseband transmit signal with a first orthogonal CDSS code; and
a receiver in communication with the duplexer, the receiver comprising:
a RF CDSS decoder configured to decode the RF receive signal using a second orthogonal CDSS code, wherein the RF CDSS decoder is implemented within the duplexer.

2. The transceiver of claim 1, wherein the second orthogonal CDSS code is delayed with respect to the first orthogonal CDSS code to compensate for a signal path delay.

3. The transceiver of claim 1, wherein the baseband CDSS encoder comprises a digital predistorter configured to compensate the first orthogonal CDSS code for a signal path delay.

4. The transceiver of claim 1, wherein the receiver RF CDSS decoder is configured to block portions of the RF receive signal that are not encoded with the second orthogonal CDSS code.

5. The transceiver of claim 1, wherein the receiver RF CDSS decoder is configured to pass portions of the RF receive signal that are encoded with the second orthogonal CDSS code.

6. The transceiver of claim 1, wherein the RF transmit signal is a spread spectrum signal encoded with the first orthogonal CDSS code.

7. The transceiver of claim 1, wherein the baseband CDSS encoder comprises a digital modulator implemented in baseband.

8. (canceled)

9. The transceiver of claim 1, wherein the RF CDSS decoder comprises an impedance tuner.

10. The transceiver of claim 1, wherein the antenna comprises a polarized antenna configured for RF domain CDSS decoding.

11. The transceiver of claim 1, further comprising a multiple-input-multiple-output (MIMO) or phase array antennae with spatial diversity for CDSS decoding.

12. The transceiver of claim 1, further comprising one or more of:
a polar transmitter with a phase lock loop (PLL) for phase modulation and a PA or a pre-PA amplifier for amplitude modulation, wherein the baseband CDSS encoder is implemented with phase data fed to the PLL and corresponding AM data fed to the PA or a pre-PA amplifier; and
a two-point-injection or phase data predistorter of the phase data configured to extend a modulation bandwidth beyond a bandwidth limit of the PLL.

13. The transceiver of claim 1,
wherein the transmitter further comprises:
an up converter in communication with the baseband CDSS encoder; and
a RF power amplifier;
and wherein the receiver further comprises:
a low noise amplifier (LNA) configured to receive a decoded RF signal from the RF CDSS decoder; and
a down converter in communication with the LNA.

14. The transceiver of claim 13, wherein the RF CDSS decoder is implemented after the duplexer and before the LNA.

15. The transceiver of claim 13, wherein the RF CDSS decoder comprises a cascode stage in the LNA.

16. A method for encoding a transmit signal in baseband and receiving and filtering a RF signal in an RF domain, the method comprising:
encoding a baseband transmit signal with a baseband CDSS encoder using a first orthogonal CDSS code;
converting the encoded baseband transmit signal to a RF transmit signal;
transmitting, with an antenna, the RF transmit signal;
receiving, with the antenna, a RF receive signal; and
decoding the RF receive signal with a RF CDSS decoder implemented within a duplexer using a delayed second orthogonal CDSS code to pass portions of the RF receive signal that are encoded with the second orthogonal CDSS code.

17. The method of claim 16, further comprising duplexing, with the duplexer, the RF receive signal to select and pass the RF receive signal to the RF CDSS decoder.

18. (canceled)

19. The method of claim 17, further comprising amplifying the decoded RF signal with a LNA, wherein the RF CDSS decoder is implemented after the duplexer and before the LNA.

20. The method of claim 16, further comprising blocking portions of the RF receive signal that are not encoded with the second orthogonal CDSS code using the RF CDSS decoder.

21. The method of claim 16, further comprising amplifying the decoded RF signal with a LNA, wherein the RF CDSS decoder comprises one or more of:
an impedance tuner;
a butterfly switch; and
a cascode stage in the LNA.

22. The method of claim 16, wherein the antenna comprises one or more of:
a polarized antenna configured for RF domain CDSS decoding; and
a multiple-input-multiple-output (MIMO) or phase array antennae with spatial diversity for CDSS decoding.

23. The method of claim 16, further comprising:
down-converting the decoded RF receive signal to produce a down-converted signal;
digitizing the down-converted signal to produce a digitized down-converted signal; and
outputting the digitized down-converted signal.

24. The method of claim 23, further comprising applying variable gain amplification to the down-converted signal.

25. The method of claim 23, further comprising synchronizing the receiving code with the transmitting code to compensate for a signal path delay.

26. The method of claim 16, further comprising:
downconverting the RF receive signal to an IF frequency signal;
processing the IF frequency signal using stretch chirp signal to compensate for a signal path delay; and
applying a group delay filter to the processed IF frequency signal.

27. The method of claim 26, wherein the stretch processing comprises a first linear frequency modulated (LFM) waveform mixed with a second LFM waveform.

28. The method of claim 16, wherein the second orthogonal CDSS code is delayed using one or more time-division path delay compensators having mean delays corresponding to a sub-distance range, wherein the delayed second orthogonal CDSS code is applied to the CDSS decoder in a time-division manner to recover signals reflected by targets located in the sub-distance ranges.

29. The method of claim 28, further comprising locking the CDSS decoder to a specific target by applying, to the second orthogonal CDSS code, a tunable delay that is adaptively configured to track the specific target over a variable distance.

30. The method of claim 16, wherein the RF CDSS decoder comprises a plurality of CDSS decoders having a combined output, and wherein the delayed second orthogonal CDSS code comprises a corresponding plurality of selectively delayed second orthogonal CDSS codes delayed by using a corresponding plurality of path delay compensators, wherein each of the selectively delayed second orthogonal CDSS codes are delayed to compensate for path delay to track targets at different distances.
